(19) United States
(12) Patent Application Publication
(10) Pub. No.: US 2025/0284459 A1
(43) Pub. Date: Sep. 11, 2025

(54) COMPUTING-IN-MEMORY DEVICE FOR INFERENCE AND LEARNING

(71) Applicant: NATIONAL CHENG KUNG UNIVERSITY, Tainan City (TW)

(72) Inventors: Lih-Yih CHIOU, Tainan City (TW); Zong-Han LI, Kaohsiung City (TW); Hong-Ming SHIH, Tainan City (TW); Shun-Hsiu HSU, Taitung County (TW); Yi-Hsuan HUNG, Nantou County (TW)

(21) Appl. No.: 18/776,981

(22) Filed: Jul. 18, 2024

(30) Foreign Application Priority Data
Mar. 5, 2024 (TW) 113107981

(51) Int. Cl. G06F 7/544

(52) U.S. Cl. CPC G06F 7/5443

(57) ABSTRACT

This disclosure presents a computing-in-memory (CIM) device, including two CIM blocks. These two blocks are connected to the same read bit lines and share an analog-to-digital converter array. The two CIM blocks can perform writing operations simultaneously in one mode. In this case, one block stores a weight matrix, while the other stores the transpose of the weight matrix. In another mode, one CIM block performs the write operation while the other conducts a multiply-accumulate operation. This CIM device can be applied in both inference and training phases.

### RELATED APPLICATION

This application claims priority to Taiwan Application Serial Number 113107981 filed Mar. 5, 2024, which is herein incorporated by reference.

### BACKGROUND

### Field of Invention

This disclosure relates to a computing-in-memory (CIM) device capable of being applied to inference and learning.

### Description of Related Art

In recent years, Artificial Intelligence (AI) has been widely applied in academia and everyday life, with the field of Machine Learning (ML) attracting significant attention. Among these, Convolutional Neural Network (CNN) has become a widely used neural network model in areas such as image recognition and object detection. With the advent of the Internet of Things (IoT) era, to reduce the data transmission between edge devices and the cloud, various manufacturers have proposed different software or hardware architectures to decrease computational load or unnecessary data transfer.

The purpose of Computing-In-Memory (CIM) is to overcome the data transmission bottleneck between the processor and memory in traditional computer systems. In conventional architectures, data storage and processing are separate; the processor needs to retrieve data from memory, process it, and then store the data back in memory. This data round-trip not only consumes time but also increases energy consumption. In contrast, CIM integrates data processing capabilities directly into memory, thereby reducing the need for data transmission and improving efficiency and speed.

### SUMMARY

Embodiments of the present disclosure provide a computing-in-memory (CIM) device including following components. A first memory block includes multiple first CIM units, in which each of the first CIM units is connected to at least one of multiple read bit lines. A second memory block includes multiple second CIM units, in which each of the second CIM units is connected to at least one of the read bit lines. A controlling circuit is configured to write multiple weights of a weight matrix into one of the first memory block and the second memory block, and control the one of the first memory block and the second memory block to perform a multiply and accumulation (MAC) operation. When the first memory block performs the MAC operation, a result of the MAC operation is applied to the read bit lines. When the second memory block performs the MAC operation, the result of the MAC operation is also applied to the read bit lines. An analog-to-digital (ADC) array is connected to the read bit lines and configured to convert multiple analog signals on the read bit lines to multiple digital signals.

In some embodiments, a number of the weight matrix is greater than 1. The weight matrices correspond to multiple filters respectively. Each of the weights includes multiple weight bits. Each of the first CIM units includes multiple first computing units. Each of the first computing units is connected to one of the read bit lines. The first computing units are arranged as multiple first memory columns and multiple first memory rows. Each of the second CIM units includes multiple second computing units. Each of the second computing units is connected to one of the read bit lines, and the second computing units are arranged as multiple second memory columns and multiple second memory rows.

In some embodiments, in a simultaneous writing mode, the controlling circuit is configured to write the weights into the first memory block and the second memory block. In the first memory block, the weights of one of the filters with different positions are stored in the first memory rows respectively, and the weight bits are stored in the first memory columns respectively. In the second memory block, the weights of different ones of the filters with a same position are stored in the second memory rows respectively, and the weight bits are stored in the second memory columns respectively.

In some embodiments, in a simultaneously writing and calculating mode, the controlling circuit is configured to control one of the first memory block and the second memory block to perform the MAC operation, simultaneously perform a writing procedure on other of the first memory block and the second memory block for writing a portion of the weights.

In some embodiments, the controlling circuit is configured to control the first memory block and the second memory block to alternatively perform the MAC operation and the writing procedure.

In some embodiments, the controlling circuit is configured to set an inference phase and a training phase. In the inference phase, the controlling circuit operates in the simultaneously writing and calculating mode.

In some embodiments, the training phase includes a forward propagation period and a backward propagation period. In the forward propagation period, the controlling circuit operates in the simultaneous writing mode and controls the first memory block to perform the MAC operation.

In some embodiments, in the backward propagation period, the controlling circuit is configured to control the second memory block to perform the MAC operation and perform the writing procedure on the first memory block or set the first memory block to be in an idle state.

In some embodiments, the first memory block and the second memory block includes multiple word lines. In the inference phase and the forward propagation, the controlling circuit is configured to apply multiple input features to the word lines. In the backward propagation period, the controlling circuit is configured to apply multiple partial derivatives of a loss with respect to the weights to the word lines.

In some embodiments, the CIM device further includes an output combiner connected to the ADC array. The output combiner includes multiple adders and a subtractor. The subtractor is configured to receive a most significant bit, and the adders are configured to receive other bits.

From another aspect, embodiments of the present disclosure provide an electronic device including the aforementioned CIM device.

### BRIEF DESCRIPTION OF THE DRAWINGS

The disclosure can be more fully understood by reading the following detailed description of the embodiment, with reference made to the accompanying drawings as follows.

FIG. 1 illustrates a block diagram of a CIM device according to one embodiment.

FIG. 2 illustrates a schematic of the MAC operation during forward propagation according to one embodiment.

FIG. 3 illustrates a schematic of the MAC operation during backward propagation according to one embodiment.

FIG. 4 illustrates the directional computation of the weights during forward propagation and backward propagation according to one embodiment.

FIG. 5 illustrates a memory configuration schematic under the simultaneous writing mode according to an embodiment.

FIG. 6 illustrates a schematic of two memory blocks performing in simultaneously writing and calculating mode according to an embodiment.

FIG. 7 illustrates the operation of the two memory blocks during the training phase according to an embodiment.

FIG. 8 illustrates a circuit schematic within a memory block according to an embodiment.

FIG. 9 illustrates the circuit schematic of an output combiner according to an embodiment.

FIG. 10 illustrates a schematic of an electronic device according to an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence.

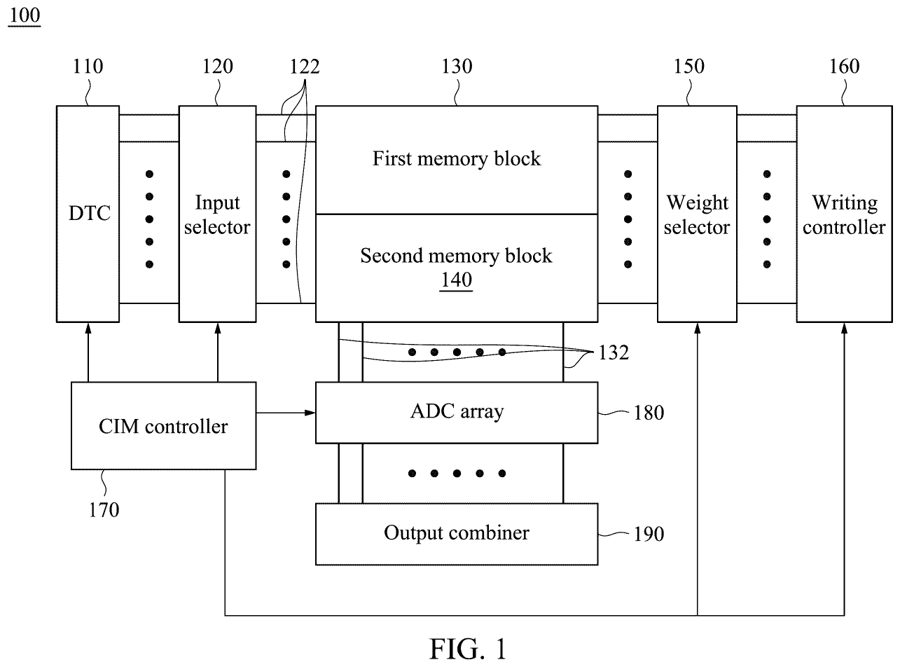

FIG. 1 illustrates a block diagram of a CIM device according to one embodiment. Referring to FIG. 1, a CIM device 100 can be implemented as a chip or a module in a circuit, and can be placed in any suitable electronic device. The CIM device 100 includes a digital time converter (DTC) 110, an input selector 120, a first memory block 130, a second memory block 140, a weight selector 150, a writing controller 160, a CIM controller 170, an ADC array 180, and an output combiner 190. The CIM controller 170 controls the DTC 110, input selector 120, weight selector 150, writing controller 160, and the ADC array 180. The input selector 120 connects to the first memory block 130 and second memory block 140 through multiple word lines 122. Furthermore, the first memory block 130 and second memory block 140 are connected to the ADC array 180 through multiple read bit lines 132. Notably, the word lines 122 and the read bit line 132 pass through the first memory block 130 and the second memory block 140, and the relevant setup will be detailed below.

In other embodiments, multiple circuits in FIG. 1 can be merged together, for example, the DTC 110 and the input selector 120 can be combined into one module, and the weight selector 150 and the writing controller 160 can be merged into one module. In some embodiments, the DTC 110, input selector 120, weight selector 150, writing controller 160, and CIM controller 170 are collectively referred to as a controlling circuit. Unless specifically mentioned, all data transmission and processing are performed by the controlling circuit, which will not be elaborated further.

The CIM device 100 is applied in Convolutional Neural Networks. The CIM controller 170 writes multiple weights from at least one weight matrix into the first memory block 130 and the second memory block 140 through the weight selector 150 and the writing controller 160. The CIM controller 170 also provides input data to the first memory block 130 and the second memory block 140 through the DTC 110 and the input selector 120. During forward propagation, the input data refer to input features; during backward propagation, the input data are partial derivatives of a loss with respect to the weights. The first memory block 130 and the second memory block 140 perform MAC (Multiply-Accumulate) operations based on the inputs and weights, notably sharing the read bit lines 132. That is, when the first memory block 130 performs the MAC operation, the result is applied to the read bit lines 132; similarly, when the second memory block 140 performs the MAC operation, its result is also applied to the read bit lines 132. Each read bit line 132 transmits a bit, and these operation results are sent in analog form to the ADC array 180, which converts the analog signals on the read bit lines 132 into digital signals, and then these digital signals are combined by the output combiner 190.

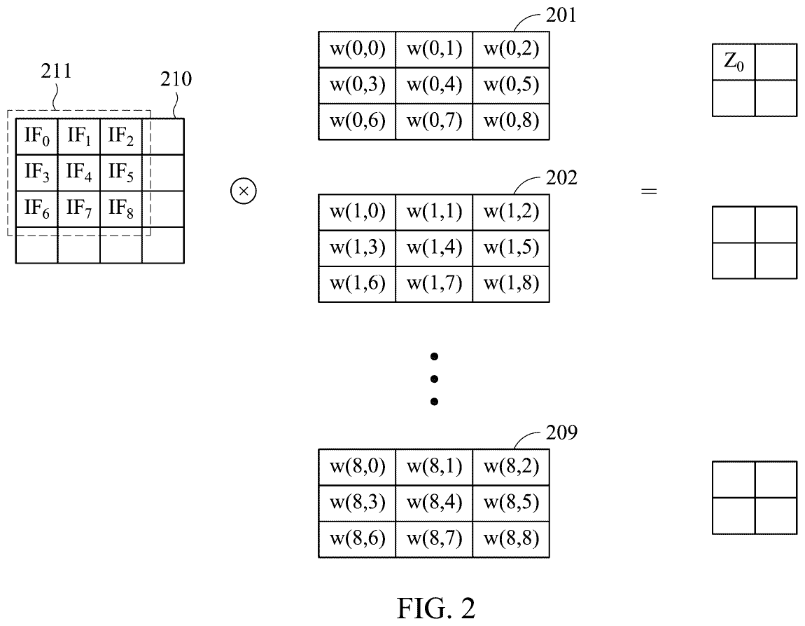

The operations of a Convolutional Neural Network include forward propagation and backward propagation. FIG. 2 illustrates a schematic of the MAC operation during forward propagation according to one embodiment. Referring to FIG. 2, in this embodiment, there are nine filters 201-209, each containing nine weights represented as w(i,j), where i and j are positive integers, i denotes the filter's sequence number, and j denotes the weight's sequence number. For example, the filter 201 contains nine weights w(0,0) to w(0,8), and so forth. FIG. 2 also shows a part of a feature map 210. The filter would slide over the feature map 210. When the filter is at a position 211, corresponding input features are IF₀ to IF₈, and the related MAC operation is shown in the following Equation 1, where Z₀ is the first result of the filter 201.

$${Z}_{0} = {IF}_{0} \times w ( 0 , 0 ) + {IF}_{1} \times w ( 0 , 1 ) + … + {IF}_{8} \times w ( 0 , 8 ) \qquad [ Equation 1 ]$$

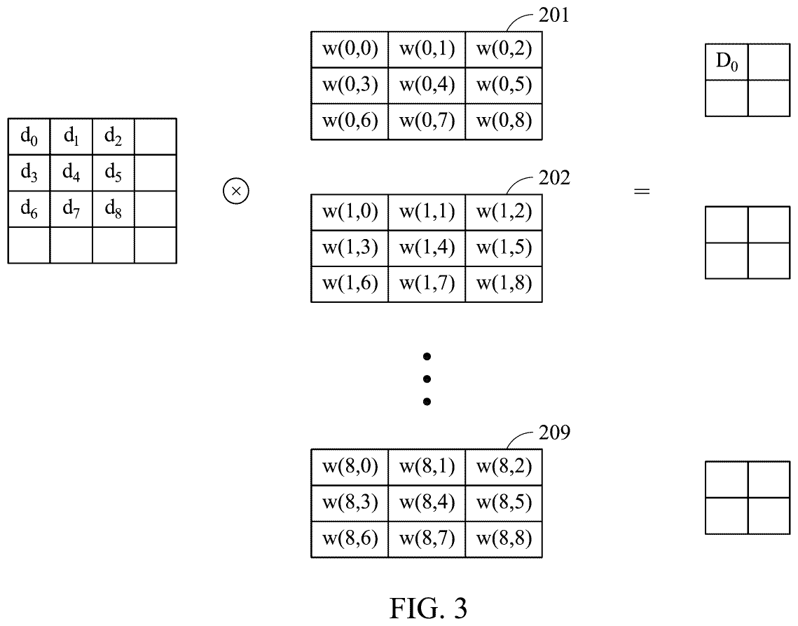

On the other hand, during the backward propagation in a training phase, the partial derivatives of the loss with respect to the weights are calculated, which indicate how the weights should be adjusted to reduce the network's prediction error. Based on the chain rule, the calculation must start from the last layer (output layer) of the network, proceed in reverse through each layer, and use the chain rule to compute the partial derivatives for each layer. In each layer, the partial derivatives also undergo MAC operations with the weights. The MAC operation during backward propagation is shown in FIG. 3 which illustrates the partial derivatives d₀˜d₈, while the filters 201-209 remain unchanged. The first result corresponding to the filter 201, D₀, is calculated as shown in the following Equation 2.

$${D}_{0} = {d}_{0} \times w ( 0 , 0 ) + {d}_{1} \times w ( 1 , 0 ) + … + {d}_{8} \times w ( 8 , 0 ) \qquad [ Equation 2 ]$$

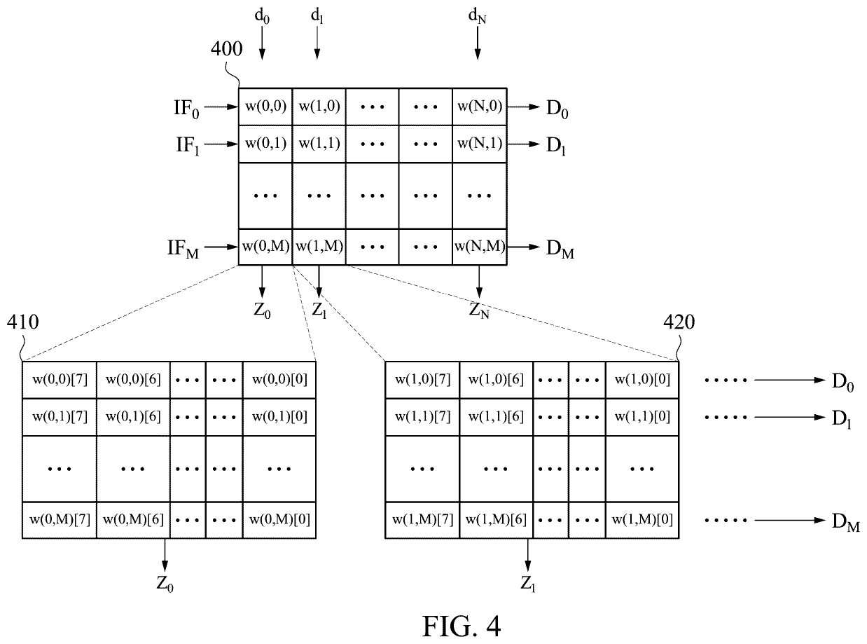

Comparing FIGS. 2 and 3, it is evident that both perform MAC operations, but the access sequence of the weights is different. In FIG. 2, the weights within the same filter are accessed, while in FIG. 3, the weights at the same position across different filters are accessed. The two MAC operations require the same weights, but the direction of computation is different. Specifically, refer to FIG. 4, which illustrates the directional computation of the weights during forward propagation and backward propagation according to one embodiment. In FIG. 4, M represents the number of weights in a filter, and N represents the number of filters, with a matrix 400 storing N×M weights. For example, the first row is arranged with weights w(0,0) to w(0,M), and the first column is arranged with weights w(0,0) to w(N,0), and so on.

In FIG. 4, the calculation direction for forward propagation is vertical, while for backward propagation, it is horizontal. Taking the first row as an example, during forward propagation, the input features IF₀ to IF_{M} are multiplied by weights w(0,0) to w(0,M), and then the results are accumulated through electric currents or charges to yield the result Z₀, while Z₁ is calculated in the second row, and so on. Taking the first column as an example, during backward propagation, the partial derivatives d₀ to d_{N} are multiplied by weights w(0,0) to w(N,0), and then the results are accumulated through electric currents or charges to yield the result D₀, while D₁ is calculated in the second column, and so on. Due to the different directions of computation, two ADC arrays are required in the known technology because the two directions cannot operate simultaneously, when one ADC array is operational, the other must be idle, leading to a waste of resources.

In some embodiments, Static Random Access Memory (SRAM) is used for Computing-In-Memory (CIM), where a computing unit (i.e. cell) can perform a calculation for one bit. If a weight consists of 8 bits (referred to as weight bits), then the first row in the matrix 400 can be expanded to be represented as a matrix 410, where w(0,0)[7] represents the 8th bit of the weight w(0,0), w(0,0)[0] represents the first bit of the weight w(0,0), and so on. Similarly, the second row in the matrix 400 can be expanded to be represented as a matrix 420.

In this embodiment, there are two memory blocks, allowing the CIM controller 170 to operate in various modes. These operating modes include a simultaneous writing mode, and a simultaneously writing and calculating mode. Additionally, this setup can be applied in both the inference phase and the training phase. The details of these modes will be further elaborated below.

In the following embodiment, each input feature and weight has 8 bits. The 8-bit input features are split into 2-bit segments and input into the memory block over four clock cycles, resulting in a 13-bit output for each MAC operation. However, this disclosure does not limit the number of bits for each input feature and weight, nor is it restricted to the aforementioned bit-splitting architecture.

### [Simultaneous Writing Mode]

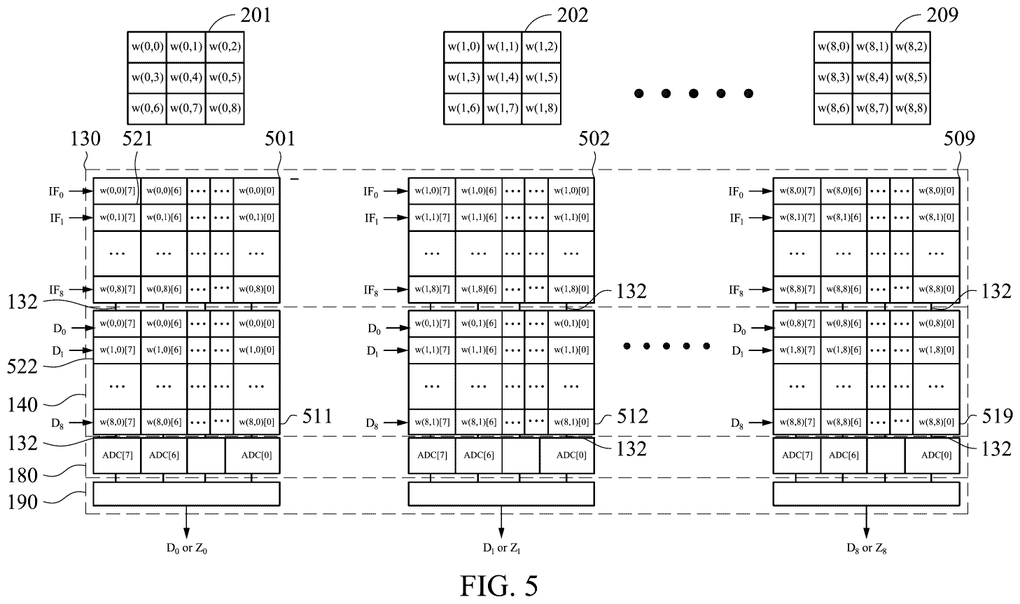

FIG. 5 illustrates a memory configuration schematic under the simultaneous writing mode according to an embodiment. Referring to FIG. 5, multiple filters 201-209 are shown, each with a weight matrix. In this embodiment, the size of the weight matrix is 3×3, although this disclosure is not limited to this size. In this embodiment, the first memory block 130 stores the weight matrix, while the second memory block 140 stores the transpose of the weight matrix. The weights required for forward propagation are written to the first memory block 130, and the weights required for backward propagation are written to the second memory block 140.

Specifically, the first memory block 130 comprises multiple CIM units 501-509. Each of the CIM units 501-509 stores the weights from all positions within a weight matrix. Each CIM unit 501-509 includes multiple computing units 521, with each computing unit 521 storing a single weight bit. These computing units 521 are arranged in multiple rows (referred to as memory rows) and columns (referred to as memory columns). Taking CIM unit 501 as an example, the first memory column stores the weight bits w(0,0)[7]-w(0,8)[7]. In the single memory column, it stores weight bits of the same sequence order (e.g., all storing the 8th weight bit). The first memory row stores the weight bits w(0,0)[7]-w(0,0)[0]. In the single memory row, it stores bits of the same weight. From another perspective, weights at different positions within filter 201 are stored in various memory rows, while the weight bits are stored in these memory columns. Each computing unit 521 is connected to one read bit line 132, and the computing units 521 in the same memory column are connected to the same read bit line 132. In this embodiment, a weight has 8 weight bits, thus CIM unit 501 is connected to 8 read bit lines 132.

Similarly, the second memory block 140 contains multiple CIM units 511-519, each comprising numerous computing units 522 arranged in rows (referred to as memory rows) and columns (referred to as memory columns). Likewise, each computing unit 522 is connected to one read bit line 132, so the CIM unit 511 is connected to 8 read bit lines 132. Taking CIM unit 511 as an example, the first memory column stores the weight bits w(0,0)[7], w(1,0)[7] . . . w(8,0)[7]; the first memory row stores the weight bits w(0,0)[7], w(0,0)[6] . . . w(0,0)[0]. This means that the weights at the same position across different filters are stored in the memory rows, while the weight bits of different orders are stored in the memory columns.

In the example of FIG. 5, input features IF₀-IF₈ are sent to the first memory block 130, and partial derivatives d₀ to de are sent to the second memory block 140. This computation aligns with FIG. 4, but the operation results are vertically transmitted on the read bit lines 132. Since the read bit lines 132 are shared, only one memory block can perform the MAC operation at a time. Regardless of which memory block performs the MAC operation, the operation results can be output through the read bit lines 132.

The ADC array 180 includes multiple Analog-to-Digital Converters (ADCs) ADC[7]-ADC[0], each of which converts the analog signal on one read bit line 132 into a digital signal. Then, the digital signals corresponding to the CIM units 501-509 are combined together through the output combiner 190, thereby outputting the partial derivatives D₀-D₈ or the results Z₀-Z₈.

### [Simultaneously Writing and Calculating Mode]

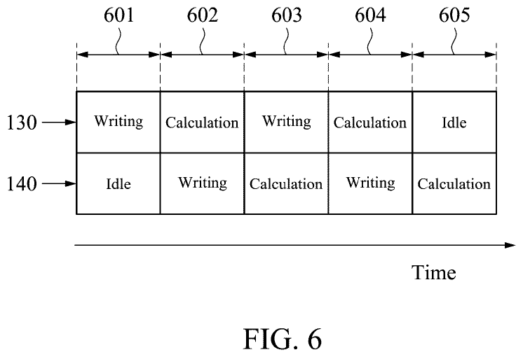

FIG. 6 illustrates a schematic of two memory blocks performing in simultaneously writing and calculating mode according to an embodiment. Referring to FIG. 6, this mode requires only forward propagation or backward propagation. In some embodiments, the number of weights is too large to load all at once, necessitating the loading of a subset of weights for the MAC operation, followed by the next batch of weights. Having two memory blocks allows for simultaneous writing and calculating, effectively reducing the overall computation time by hiding the writing time within the computing time. At any given time interval, at most one memory block can perform the MAC operation. For example, multiple time intervals 601-605 can be set. During the time interval 601, the first memory block 130 performs a writing procedure to load a subset of weights, while the second memory block 140 remains idle. During the time interval 602, the first memory block 130 performs the MAC operation, while the second memory block 140 carries out the writing procedure. During the time interval 603, the first memory block 130 undergoes the writing procedure, while the second memory block 140 performs the MAC operation, and so on. Notably, when the first and second memory blocks 130 and 140 perform forward propagation together, both store the weight matrix in the same orientation; if they perform backward propagation together, both store the transpose of the weight matrix. Whether for forward or backward propagation, the first and second memory blocks 130 and 140 alternatively perform the MAC operation and the writing procedure. This architecture fully utilizes the ADC array 180, enhancing overall efficiency and reducing computation latency. Compared to the known technology that uses two sets of DTC and ADC arrays, the embodiment in FIG. 6 shares these hardware components, which can reduce circuit area and power consumption, achieving up to a 28% reduction in power consumption in some experiments.

### [Overall Operations]

Convolutional Neural Network operations can be divided into three scenarios. The first scenario is the inference phase, where the controlling circuit operates in simultaneously writing and calculating mode. In this scenario, weights are alternately loaded into the first memory block 130 and the second memory block 140, and the MAC operations are performed based on these weights and the input features. The operational schematic is illustrated in FIG. 6.

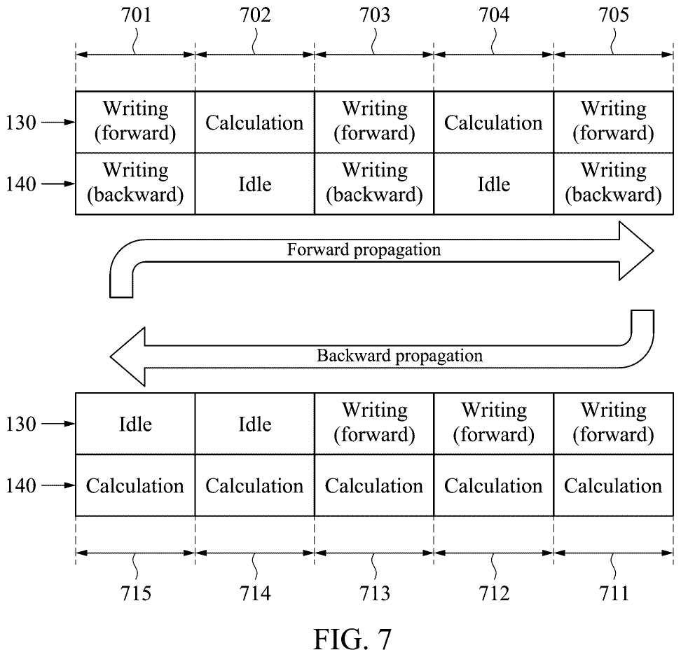

The second scenario is the forward propagation during the training phase, and the third scenario is the backward propagation during the training phase. Both scenarios can be realized using the two memory blocks. FIG. 7 illustrates the operation of the two memory blocks during the training phase according to an embodiment. Referring to FIG. 7, during the forward propagation, the controlling circuit operates in simultaneous writing mode. In FIG. 7, “writing (forward)” refers to writing weights in the order required for forward propagation, while “writing (backward)” refers to writing weights in the order required for backward propagation. During a time interval 701, both the first memory block 130 and the second memory block 140 perform the writing procedure, where the written weights follow the arrangement shown in FIG. 5. During a time interval 702, the first memory block 130 performs the MAC operation, while the second memory block 140 is idle. Time intervals 703-705 can be inferred similarly.

During the backward propagation, the controlling circuit controls the second memory block 140 to perform the MAC operation, while the first memory block 130 either undergoes a writing procedure or is set to an idle state. Specifically, during time intervals 711-713, the second memory block 140 performs the MAC operation, and the first memory block 130 undergoes a writing procedure, such as writing updated weights to prepare for the forward propagation of the next sample. During a time interval 714, the second memory block 140 continues the MAC operation, while the first memory block 130 remains idle. Thus, the CIM device 100 can be used for both the inference phase and the training phase, and the shared use of the ADC array 180 can save circuit area and power consumption.

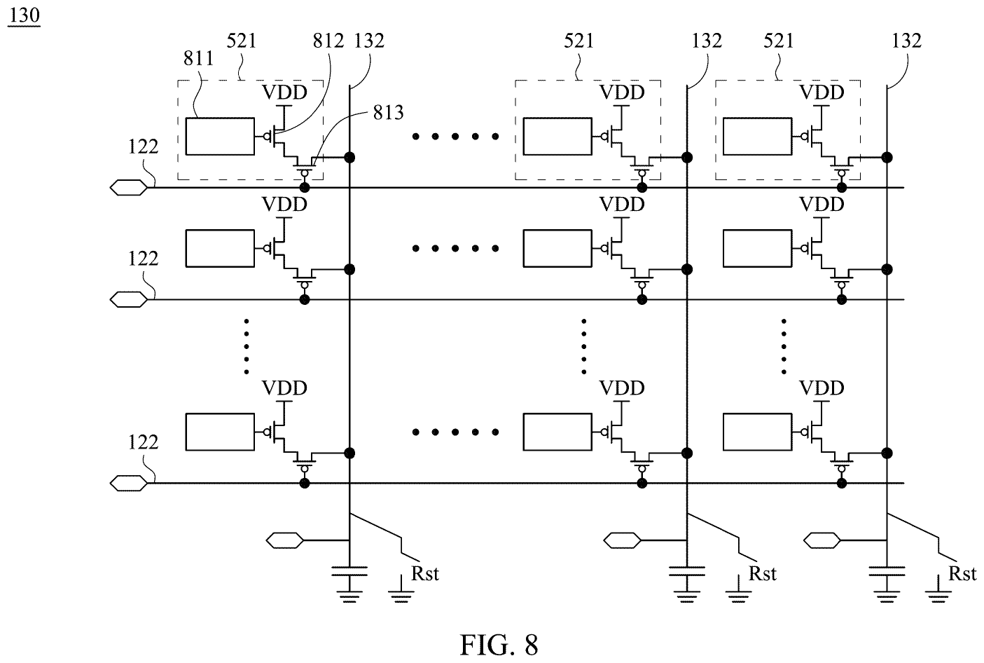

FIG. 8 illustrates a circuit schematic within a memory block according to an embodiment. Here, the first memory block 130 is used as an example, but the circuit structure of the second memory block 140 is the same as that of the first memory block 130, hence it is not elaborated further. The first memory block 130 contains multiple computing units 521 arranged in a matrix. The number of rows in the matrix is equal to the number of bits in a weight multiplied by the number of filters, which is 8×9=72 rows in this embodiment. The number of columns in the matrix corresponds to the number of weights in a filter, which is 9 columns in this embodiment. Each computing unit 521 is connected to a read bit line 132 and a word line 122, with each read bit line 132 connected to a reset switch Rst. Each computing unit 521 includes a Static Random Access Memory (SRAM) cell 811, a switch 812, and a switch 813. The SRAM cell 811 contains six transistors, while switches 812 and 813 are each a single transistor, thus the computing unit 521 can also be referred to as an 8T (eight-transistor) SRAM computing unit.

The SRAM cell 811 stores a single weight bit. When this weight bit is “1”, it turns on the switch 812, and conversely, it turns off the switch 812. On the other hand, when performing a MAC operation, the switch 813 can be turned on or off based on the signal on the word line 122. Specifically, during the forward propagation, each bit of the input features is applied to a word line, turning on the switch 813 if this bit is “1”. If the weight bit is also “1”, a current will be generated from the system voltage VDD into the corresponding read bit line 132, and the currents generated by the computing units 521 on the same column will accumulate. If the bit of the input features is “0” or the weight bit is “0”, no current will flow into the read bit line 132. During the backward propagation, the partial derivatives of the loss with respect to the weights are applied to the word lines 122, and the operation is similar to the forward propagation. Using 8T SRAM for the computing unit has the advantage of a larger static noise margin, allowing for operation at lower voltages to save power consumption. Another advantage is that the parasitic capacitance on the read bit line 132 is not a stable value and can change due to manufacturing or layout differences. Therefore, by fine-tuning the operating voltage of the SRAM, it can provide a consistent current to the read bit line 132 under different process variations.

Referring to FIG. 1, the analog signals on the read bit lines 132 are transmitted to the ADC array 180, which includes multiple Analog-to-Digital Converters (ADCs) that convert the analog signals on the read bit lines 132 into digital signals. In this example, a digital signal consists of 4 bits. Any type of Analog-to-Digital Converter can be used in this context, and this disclosure is not limited to a specific type of ADC.

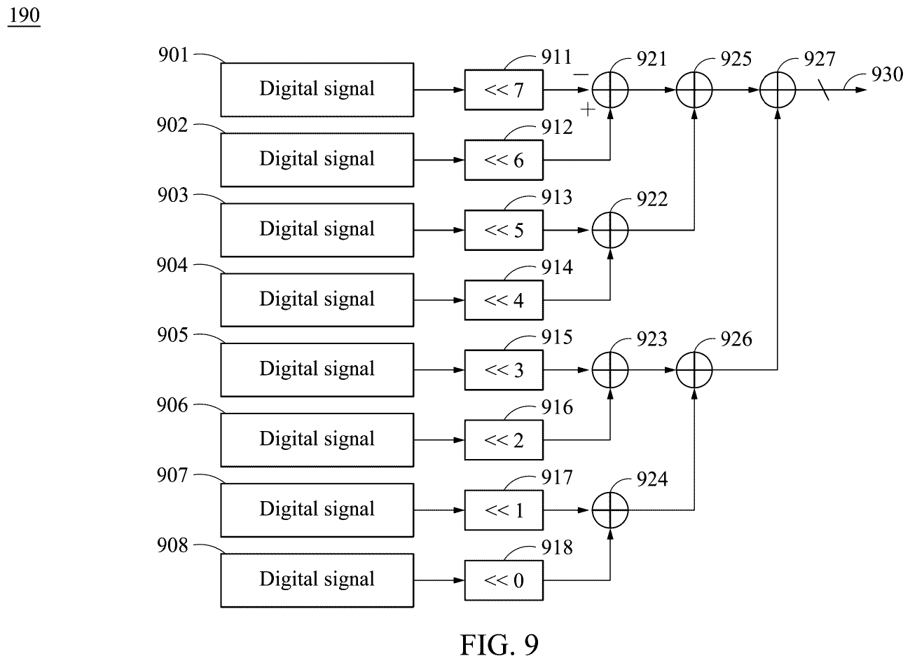

In this embodiment, MAC operations are performed on a bit-by-bit basis, which offers better resistance to process variations. This is advantageous because the amount of data that needs to be quantized is reduced, and the process can be managed using digital circuitry, avoiding unnecessary errors. However, this setup requires an output combiner 190 to merge the outputs from different weights. FIG. 9 illustrates the circuit schematic of an output combiner according to an embodiment. Referring to FIG. 9, take a CIM unit as an example, there are eight digital signals 901-908, each consisting of 4 bits. The output combiner 190 includes multiple shifters 911-918 that shift the digital signals 901-908, respectively. The output combiner 190 also includes a subtractor 921 and multiple adders 922-927. The subtractor 921 receives the most significant bit, and the remaining bits are processed by the adders 922-924, then further processed by the adders 925-927, resulting in a 12-bit signed output 930. In this embodiment, the output 930 is signed, indicating it can represent both positive and negative values.

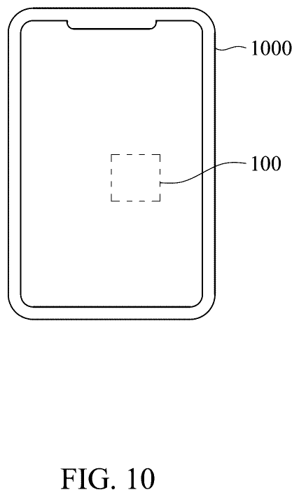

FIG. 10 illustrates a schematic of an electronic device according to an embodiment. Referring to FIG. 10, from another perspective, this disclosure also provides an electronic device 1000 that includes the aforementioned CIM device 100. The electronic device 1000 can be implemented as a smartphone, tablet, laptop, other forms of mobile devices, home appliances, etc., and is not limited to these examples.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computing-in-memory (CIM) device, comprising:
a first memory block, comprising a plurality of first CIM units, wherein each of the first CIM units is connected to at least one of a plurality of read bit lines;
a second memory block, comprising a plurality of second CIM units,
wherein each of the second CIM units is connected to at least one of the read bit lines;
at least one controlling circuit, configured to write a plurality of weights of at least one weight matrix into one of the first memory block and the second memory block, and control the one of the first memory block and the second memory block to perform a multiply and accumulation (MAC) operation, wherein when the first memory block performs the MAC operation, a result of the MAC operation is applied to the read bit lines, wherein when the second memory block performs the MAC operation, the result of the MAC operation is applied to the read bit lines; and
an analog-to-digital (ADC) array, connected to the read bit lines and configured to convert a plurality of analog signals on the read bit lines to a plurality of digital signals.

2. The CIM device of claim 1, wherein a number of the at least one weight matrix is greater than 1, the weight matrices correspond to a plurality of filters respectively, each of the weights comprises a plurality of weight bits, each of the first CIM units comprises a plurality of first computing units, each of the first computing units is connected to one of the read bit lines, and the first computing units are arranged as a plurality of first memory columns and a plurality of first memory rows,
wherein each of the second CIM units comprises a plurality of second computing units, each of the second computing units is connected to one of the read bit lines, and the second computing units are arranged as a plurality of second memory columns and a plurality of second memory rows.

3. The CIM device of claim 2, wherein in a simultaneous writing mode, the at least one controlling circuit is configured to write the weights into the first memory block and the second memory block,
wherein in the first memory block, the weights of one of the filters with different positions are stored in the first memory rows respectively, and the weight bits are stored in the first memory columns respectively,
wherein in the second memory block, the weights of different ones of the filters with a same position are stored in the second memory rows respectively, and the weight bits are stored in the second memory columns respectively.

4. The CIM device of claim 3, wherein in a simultaneously writing and calculating mode, the at least one controlling circuit is configured to control one of the first memory block and the second memory block to perform the MAC operation, simultaneously perform a writing procedure on other of the first memory block and the second memory block for writing a portion of the weights.

5. The CIM device of claim 4, wherein the at least one controlling circuit is configured to control the first memory block and the second memory block to alternatively perform the MAC operation and the writing procedure.

6. The CIM device of claim 5, wherein the at least one controlling circuit is configured to set an inference phase and a training phase,
wherein in the inference phase, the at least one controlling circuit operates in the simultaneously writing and calculating mode.

7. The CIM device of claim 6, wherein the training phase comprises a forward propagation and a backward propagation,
wherein in the forward propagation, the at least one controlling circuit operates in the simultaneous writing mode and control the first memory block to perform the MAC operation.

8. The CIM device of claim 7, wherein in the backward propagation, the at least one controlling circuit is configured to control the second memory block to perform the MAC operation and perform the writing procedure on the first memory block or set the first memory block to be in an idle state.

9. The CIM device of claim 8, wherein the first memory block and the second memory block comprises a plurality of word lines,
wherein in the inference phase and the forward propagation, the at least one controlling circuit is configured to apply a plurality of input features on the word lines,
wherein in the backward propagation, the at least one controlling circuit is configured to apply a plurality of partial derivatives of a loss with respect to the weights to the word lines.

10. The CIM device of claim 9, further comprising:
an output combiner, connected to the ADC array, wherein the output combiner comprises a plurality of adders and a subtractor, and the subtractor is configured to receive a most significant bit, and the adders are configured to receive other bits.

11. An electronic device, comprising:
a computing-in-memory (CIM) device, comprising:
a first memory block, comprising a plurality of first CIM units, wherein each of the first CIM units is connected to at least one of a plurality of read bit lines;
a second memory block, comprising a plurality of second CIM units, wherein each of the second CIM units is connected to at least one of the read bit lines;
at least one controlling circuit, configured to write a plurality of weights of at least one weight matrix into one of the first memory block and the second memory block, and control the one of the first memory block and the second memory block to perform a multiply and accumulation (MAC) operation, wherein when the first memory block performs the MAC operation, a result of the MAC operation is applied to the read bit lines, wherein when the second memory block performs the MAC operation, the result of the MAC operation is applied to the read bit lines; and
an analog-to-digital (ADC) array, connected to the read bit lines and configured to convert a plurality of analog signals on the read bit lines to a plurality of digital signals.

12. The electronic device of claim 11, wherein a number of the at least one weight matrix is greater than 1, the weight matrices correspond to a plurality of filters respectively, each of the weights comprises a plurality of weight bits, each of the first CIM units comprises a plurality of first computing units, each of the first computing units is connected to one of the read bit lines, and the first computing units are arranged as a plurality of first memory columns and a plurality of first memory rows,
wherein each of the second CIM units comprises a plurality of second computing units, each of the second computing units is connected to one of the read bit lines, and the second computing units are arranged as a plurality of second memory columns and a plurality of second memory rows.

13. The electronic device of claim 12, wherein in a simultaneous writing mode, the at least one controlling circuit is configured to write the weights into the first memory block and the second memory block,
wherein in the first memory block, the weights of one of the filters with different positions are stored in the first memory rows respectively, and the weight bits are stored in the first memory columns respectively,
wherein in the second memory block, the weights of different ones of the filters with a same position are stored in the second memory rows respectively, and the weight bits are stored in the second memory columns respectively.

14. The electronic device of claim 13, wherein in a simultaneously writing and calculating mode, the at least one controlling circuit is configured to control one of the first memory block and the second memory block to perform the MAC operation, simultaneously perform a writing procedure on other of the first memory block and the second memory block for writing a portion of the weights.

15. The electronic device of claim 14, wherein the at least one controlling circuit is configured to control the first memory block and the second memory block alternatively perform the MAC operation and the writing procedure.
